(19) United States
(12) Patent Application Publication
(10) Pub. No.: US 2026/0161439 A1
(43) Pub. Date: Jun. 11, 2026

(54) VISUAL MONITORING SYSTEM FOR BALANCING SERVER LOADS AND VIRTUAL RESOURCES

(71) Applicant: SYSCOM COMPUTER ENGINEERING CO., TAIPEI CITY (TW)

(72) Inventors: JERRY YEN, TAIPEI CITY (TW); CHE-KANG CHANG, TAIPEI CITY (TW); KUO-TUNG TSENG, TAIPEI CITY (TW)

(21) Appl. No.: 18/974,823

(22) Filed: Dec. 10, 2024

(51) Int. Cl. G06F 9/455; G06F 9/50

(52) U.S. Cl. CPC G06F 9/45558; G06F 9/5077; G06F 2009/4557

(57) ABSTRACT

A visual monitoring system for balancing server loads and virtual resources includes a data monitoring processor, a data analysis processor, an alarm processor, a flow plotting processor and a display processor. The data analysis processor includes a load balancing weight calculation model. The data monitoring processor is connected to at least one server load balancer and at least one virtual machine which are polled to obtain load status data and resource pool status data. The data analysis processor obtains an average load data and an average resource data after computing the data corresponding to the transmission protocol. The alarm processor compares each of the average load data and average resource data with an alarm value and outputs an alarm signal for errors. The flow plotting processor compiles and generates at least one integrated flow variation diagram of a topology diagram for the display processor to display in real time.

### BACKGROUND OF THE DISCLOSURE

### Technical Field

The present disclosure relates to a network monitoring system, and more particularly relates to a visual monitoring system for balancing server loads and virtual resources.

### Description of the Related Art

As the demand for network services grows rapidly, the flow load on servers also increases, making it difficult for a single server to handle a large number of access requests, which can easily lead to the overload of system resources, prolonged response times and even service interruptions. Therefore, Server Load Balancing (SLB) technology becomes the key to the network management system, which is used to distribute user requests to multiple servers to ensure that each server can evenly assign their workload. However, the current SLB application lacks a visual interface, making it difficult for administrators to quickly grasp the dynamic resource changes, and due to the lack of an intuitive graphical display, it is difficult for administrators to understand the load status of the servers, the flow distribution and potential bottlenecks in real time.

Moreover, in the current network management architecture, SLB and virtual machine (VM) are usually managed separately, which makes it difficult for administrators to keep track of the flow changes of both at once and in a comprehensive manner, and makes the backend management of network systems more difficult after the development of more and more diversified types of network resources. In other words, due to the lack of a unified management platform, administrators need to monitor and adjust the resources of SLBs and VMs separately, which not only increases the complexity of management, but also may lead to unsynchronized data and flow change information. In view of this, how to provide a management system that integrates SLB and VM monitoring functions and presents the current flow information in a graphical visual interface, so that administrators can easily manage the resources of SLB and VM in a unified way at one time to improve aforementioned drawbacks of the related art is exactly the main topic what the present disclosure is intended to explore.

### SUMMARY OF THE DISCLOSURE

It is a primary objective of the present disclosure to provide a network monitoring system that can simultaneously visualize the flow of a server load balancer (SLB) and a virtual machine (VM) to enable administrators to centralize management and monitor the flow conditions of the SLB and VM in real time through an intuitive graphical interface to enhance management efficiency.

To achieve the aforementioned objective, the present disclosure discloses a visual monitoring system for balancing server loads and virtual resources, which includes a data monitoring processor, a data analysis processor, an alarm processor and a display processor, the data monitoring processor is connected to at least one server load balancer and at least one virtual machine, the data analysis processor is connected to the data monitoring processor and the alarm processor, and the alarm processor is connected to the display processor, characterized in that: the visual monitoring system includes a flow plotting processor, connected between the alarm processor and the display processor, and the data analysis processor includes a load balancing weight calculation model; the data monitoring processor polls the server load balancers to obtain a plurality of load status data through at least one transmission protocol and polls the virtual machines to obtain a plurality of resource pool status data through at least one the transmission protocol, and the data analysis processor uses the load balancing weight calculation model to compute the load status data and the resource pool status data corresponding to the at least one transmission protocol for a period of time to obtain an average load data and an average resource data; the alarm processor uses a built-in alarm value to compare each of the average load data and each of the average resource data, and outputs an alarm signal when an error occurs, the flow plotting processor compiles each of the average load data and each of the average resource data to generate at least one integrated flow variation diagram of a topology diagram provided for the display processor to display the integrated flow variation diagram and the alarm signal in real time.

Wherein, the data monitoring processor polls the server load balancer through the transmission protocols such as Simple Network Management Protocol (SNMP), Application Programming Interface (API) and Syslog to obtain the load status data including performance, flow, and error conditions, at the same time, the data monitoring processor polls the virtual machine through the transmission protocols such as SNMP and API to obtain the resource pool status data including resource usage, performance indicators and error messages; and the data analysis processor accumulates the load status data corresponding to each of the transmission protocols within the period of time and assigns weights to calculate the average load data; and similarly accumulates the resource pool status data corresponding to each of the transmission protocols within the period of time and assigns weight to calculate the average resource data. The data monitoring processor is configured to poll the server load balancer and the virtual machine through the transmission protocols of SNMP and API to collect data every N seconds, and to poll the server load balancer through the transmission protocol of Syslog to collect data every M seconds.

When the data analysis processor checks and learns that the received load status data corresponds to three types of transmission protocols, respectively SNMP, API and Syslog, the load balancing weight calculation model uses a weight ratio of A:B:C to perform data fusion and calculate an average of the load status data to obtain the average load data during the period. When the data analysis processor checks and learns that the received load status data corresponds to two types of transmission protocols, respectively SNMP and API but cannot obtain the load status data corresponding to Syslog, the load balancing weight calculation model uses the weight ratio of D:E to perform data fusion and calculate an average of the load status data to obtain the average load data during the period. When the data analysis processor checks and learns that the received resource pool status data corresponds to two types of transmission protocols, respectively SNMP and API, the load balancing weight calculation model uses the weight ratio of D:E to perform data fusion and calculate an average of the resource pool status data to obtain the average resource data during the period. The period is 1-10 minutes, N and M seconds are 1-10 seconds, A:B:C is 2:1:7, and D:E is 6:4.

When the data analysis processor checks and receives the load status data and the resource pool status data, the load balancing weight calculation model evaluates the data variability by calculating the standard deviation of each data source through a formula, and combines data from different sources for trend analysis; and, the load balancing weight calculation model is based on the fused data to perform anomaly detection to identify abnormal situations in real time. The visual monitoring system further includes a task sending processor connected to the alarm processor and the flow plotting processor and provided for designing system tasks and performing allocation and management; and the alarm processor is an intelligent learning model provided for continuously using history data and trend to automatically calculate and adjust the alarm value, so as to achieve the effect of intelligently enhancing the accuracy of the alarm signal. The visual monitoring system further includes an automatic program processor connected to the task sending processor, such that when the task sending processor receives the alarm signal, the automatic program processor automatically checks a task list in the task sending processor, and adjusts a plurality of execution tasks in the task list according to the alarm signal.

In summation of the description above, the present disclosure relates to a monitoring system that visually manages the flow of the SLB and VM through the data monitoring processor, the load balancing weight calculation model and the flow plotting processor. In other words, the present disclosure uses the polling of the data monitoring processor to obtain data corresponding to each transmission protocol, and then uses the load balancing weight calculation model to calculate high-reliability average data by re-assigning weights to improve the accuracy of the comparison and determination errors of the alarm processor, and the flow plotting processor is then used to instantly generate and update the integrated flow variation diagram, which is then displayed in real time through the intuitive graphical interface of the display processor. In this way, it is convenient for managers to use intuitive visual checking to fully understand the operation status of the overall network system, including flow direction, resource usage, performance indicators, etc. In addition, through the settings of the automatic program processor, when the alarm processor outputs the alarm signal, the automatic program processor is triggered to adjust the execution tasks in the task list to automatically send and process the next task, such as issuing an alarm signal, blocking source IPs, conducting compliance rule reviews, backing up network settings, and performing other network management operations and management change operations, etc., so as to reduce the administrator's workload and improve management quality and efficiency.

### BRIEF DESCRIPTION OF THE DRAWINGS

FIG. 1 is a schematic view showing the architecture of a first preferred embodiment of the present disclosure;

FIG. 2 is a schematic view showing the architecture of a second preferred embodiment of the present disclosure;

FIG. 3 is a flow chart of the second preferred embodiment of the present disclosure; and

FIG. 4 is a schematic view showing a system application of the second preferred embodiment of the present disclosure.

### DETAILED DESCRIPTION OF THE DISCLOSURE

To make it easier for the persons ordinary skilled in the art to understand the content of the present disclosure, the specification accompanied by the drawings is described as follows.

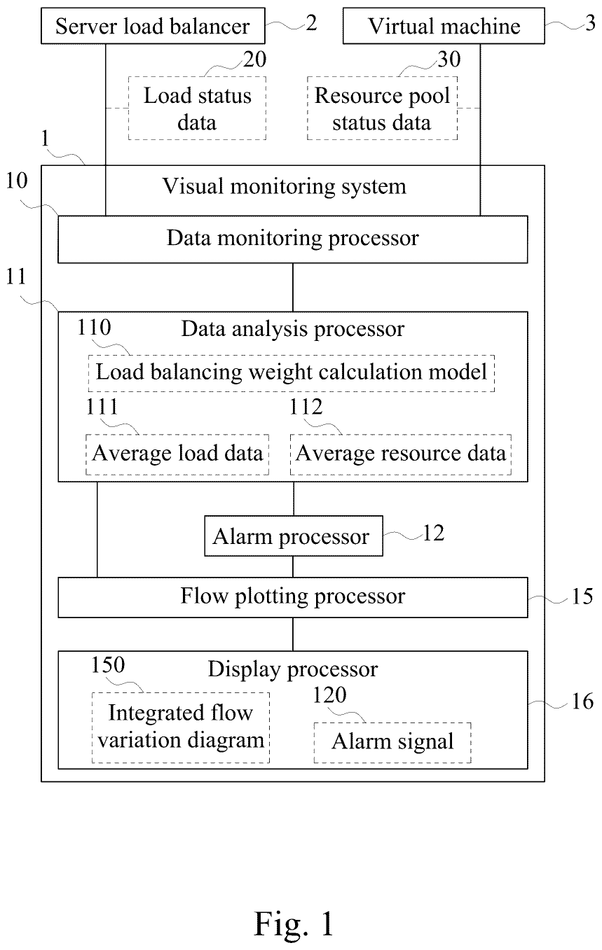

With reference to FIG. 1 for the schematic view showing the architecture of a first preferred embodiment of the present disclosure, the visual monitoring system for balancing server loads and virtual resources 1 includes a data monitoring processor 10, a data analysis processor 11, an alarm processor 12, a flow plotting processor 15 and a display processor 16, and the data analysis processor 11 includes a load balancing weight calculation model 110. The data monitoring processor 10 is connected to at least one external server load balancer 2 and at least one external virtual machine 3, the data analysis processor 11 is connected to the data monitoring processor 10 and the alarm processor 12, the alarm processor is connected to the flow plotting processor 15, and the flow plotting processor 15 is connected to the display processor 16.

The data monitoring processor 10 polls the server load balancer 2 through at least one of the transmission protocols to obtain a plurality of load status data 20, and the data monitoring processor 10 synchronously polls the virtual machine 3 through at least one of the transmission protocols to obtain a plurality of resource pool status data 30. The data analysis processor 11 uses the load balancing weight calculation model 110 to compute the load status data 20 and the resource pool status data 30 corresponding to the transmission protocol within a period of time to obtain an average load data 111 and an average resource data 112. The alarm processor 12 uses a built-in alarm value to compare with each of the average load data 111 and each of the average resource data 112, and outputs an alarm signal 120 when an error occurs. The flow plotting processor 15 receives and sends the alarm signal 120 to the display processor 16, and the flow plotting processor 15 compiles each of the average load data 111 and each of the average resource data 112 to generate at least one integrated flow variation diagram 150 of a visualized topology diagram, and the display processor 16 is provided to display the integrated flow variation diagram 150 and the alarm signal 120. Therefore, through the visual integrated flow variation diagram 150, the flow direction, resource usage situation and performance indicator of the server load balancer 2 and the virtual machine 3 are displayed simultaneously in real time and provided for administrators to centralize the management and monitor the server load balancer 2 and the virtual machine 3, so as to comprehensively grasp the operation conditions of the system and enhance the performance and efficiency of management.

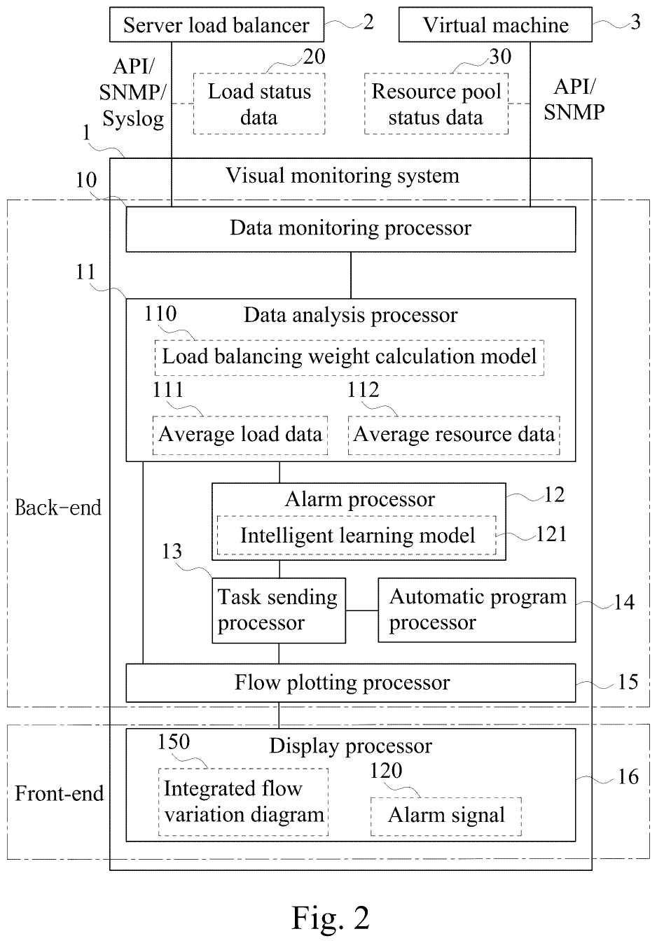

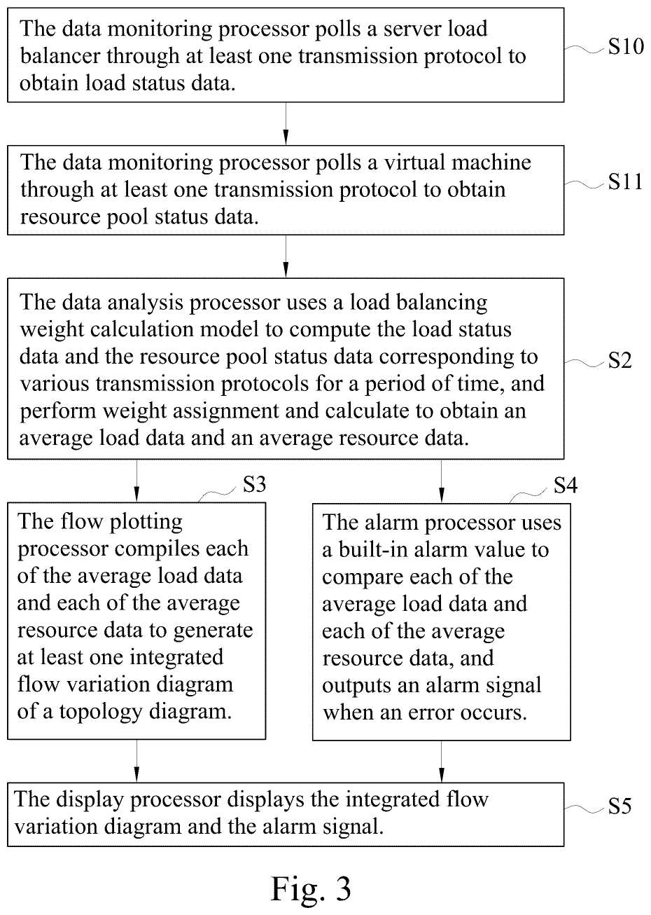

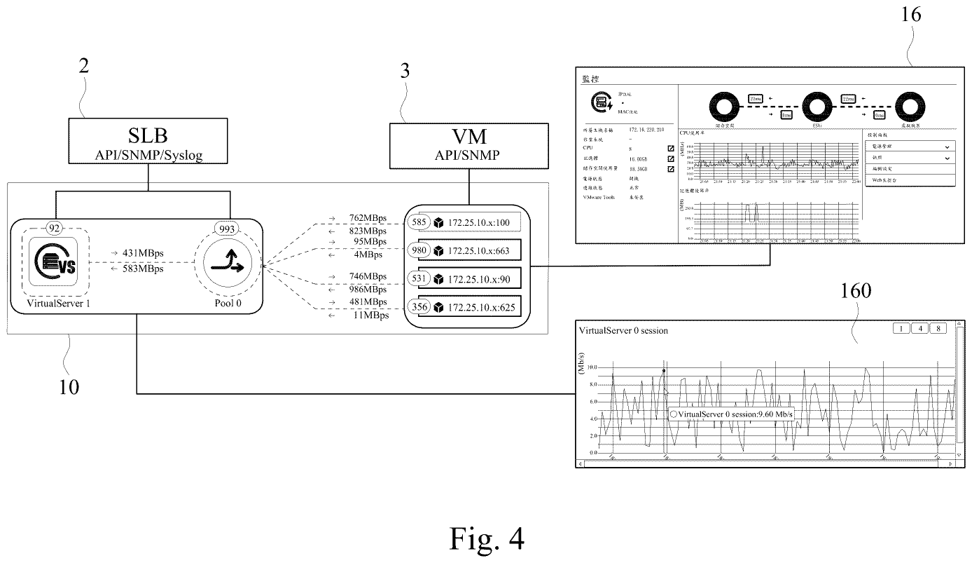

With reference to FIGS. 2-4 for the schematic architectural diagram, the flow chart and the schematic system application diagram of the second preferred embodiment of the present disclosure respectively, the visual monitoring system for balancing server loads and virtual resources 1 includes a data monitoring processor 10, a data analysis processor 11, an alarm processor 12, a task sending processor 13, an automatic program processor 14, a flow plotting processor 15 and a display processor 16. The data analysis processor 11 includes a load balancing weight calculation model 110. The data monitoring processor 10 is connected to the data analysis processor 11, at least one external server load balancer 2 and at least one external virtual machine 3, and the at least one external server load balancer 2 and the at least one external virtual machine 3 are common virtual devices of VMware, Nutanix, etc. The data analysis processor 11 is connected to the alarm processor 12 and the flow plotting processor 15, the alarm processor 12 is connected to the task sending processor 13, the task sending processor 13 is connected to the automatic program processor 14 and the flow plotting processor 15, and the flow plotting processor 15 is connected to the display processor 16. The task sending processor 13 is provided for administrator to perform system task assignment and manage system tasks, and the application operation process of the visual monitoring system 1 includes the following steps:

After a system administrator uses the task sending processor 13 to design system tasks and perform task assignment and management, in Step (S10), the data monitoring processor 10 polls the server load balancer 2 through at least one transmission protocol, such as SNMP, API and Syslog to obtain a plurality of load status data 20. Synchronously, in Step (S11), at least one the transmission protocol is used to poll the virtual machine 3 to obtain a plurality of resource pool status data 30. For example, the data monitoring processor 10 polls the server load balancer 2 through the transmission protocols of SNMP, API and Syslog to obtain the load status data 20 including performance, flow and error conditions, and the data monitoring processor 10 synchronously polls the virtual machine 3 through the transmission protocols of SNMP and API to obtain the resource pool status data 30 including resource usage, performance indicators and error messages. Wherein, the data monitoring processor 10 takes the advantages and disadvantages of each transmission protocol into account to set polling the server load balancer 2 and the virtual machine 3 through the transmission protocol of SNMP to collect data every N seconds, in order to obtain the equipment performance data, the health status, the flow statistics information, etc., and to set polling the server load balancer 2 and the virtual machine 3 through the transmission protocol of API to collect data such as detailed equipment configuration, status and flow data, etc. every N seconds, so as to enrich and complete the types of data collected; and set a frequency of polling the server load balancer 2 through the transmission protocol of Syslog to collect data every M seconds, so as to obtain records such as detailed log information, device operating status, error, alarm, flow, etc. Among them, N and M seconds can be 1-10 seconds.

Since the frequency for the data monitoring processor 10 to obtain the load status data 20 and the resource pool status data 30 of three types of transmission protocols, respectively SNMP, API and Syslog is not consistent, and the number of samples obtained is also different, therefore in order to ensure the accuracy of data, in Step S2, the data analysis processor 11 uses the load balancing weight calculation model 110 to compute the load status data 20 and the resource pool status data 30 corresponding to various transmission protocols for a period of time, such as 1-10 minutes and perform weight assignment and calculate to obtain an average load data 111 and an average resource data 112. For example, when the data analysis processor 11 receives the load status data 20, the received load status data 20 is checked, and learned that they correspond to the three types of transmission protocols, respectively SNMP, API and Syslog, the load balancing weight calculation model 110 uses the weight ratio of A:B:C such as 2:1:7, that is SNMP occupies 20%, API occupies 10% and Syslog occupies 70% to perform data fusion and calculate an average of the load status data 20, so as to obtain the average load data 111 during the period. When the data analysis processor checks and learns that the received load status data 20 corresponds to the two types of transmission protocols of SNMP and API but cannot obtain the load status data 20 corresponding to the transmission protocol of Syslog, the load balancing weight calculation model 110 uses a weight ratio of D:E such as 6:4, that is, SNMP occupies 60% and API occupies 40% to perform data fusion and calculate an average of the load status data 20, so as to obtain the average load data 111 within the period.

When the data analysis processor 11 checks and learns that the received resource pool status data 30 corresponds the two types of transmission protocols of SNMP and API, the load balancing weight calculation model 110 uses the weight ratio of D:E to perform data fusion and calculate the resource pool status data 30 to obtain the average resource data 112 during the period. It is noteworthy that when the data analysis processor 11 checks and receives the load status data 20 and the resource pool status data 30, the load balancing weight calculation model 110 further evaluates the data variability by calculating the standard deviation of each data source through a formula, and combines data from different sources for trend analysis; and the load balancing weight calculation model 110 perform anomaly detection based on the fused data, such as performing a Z-Score anomaly detection and timely identifying the abnormal situation by the formula

$$Z = \frac{X - u}{σ} ,$$

wherein X is the current data point, u is the average load data 111 or the average resource data 112, σ is the standard deviation of data, and Z is the determined abnormality that exceeds the threshold value. Of course, the data analysis processor 11 can further analyze the data to identify the potential trends and potential abnormal problems, and generate an analysis report to assist administrators in revising management strategies or formulating corresponding methods in advance.

In Step (S3), the flow plotting processor 15 compiles each of the average load data 111 and each of the average resource data 112 and bases on this to generate at least one integrated flow variation diagram 150 of a visual topology diagram, which displays summarized information through page components, and allows users to click on this page component to enter and view detailed information, thereby achieving the effect of displaying flow trends and resource usage in real time through an intuitive graphical interface. In Step (S4), the alarm processor 12 synchronously uses a built-in alarm value to compare each of the average load data 111 and each of the average resource data 112, and outputs an alarm signal 120 when an error occurs. In Step (S5), after the display processor 16 receives the alarm signal 120 from the alarm processor 12, and the integrated flow variation diagram 150 of the flow plotting processor 15, integration and display are carried out and provided for system administrators or network administrators to grasp the flow direction and resources usage situation intuitively through the display processor 16, and further view detailed information after clicking. In this way, the present disclosure enables administrators to simultaneously perform integrated management of the real-time flow variability of the server load balancer 2 and the virtual machine 3 and accurately grasp the operation status of the system, so as to achieve the effect of enhancing management efficiency.

Additionally, when the task sending processor 13 receives the alarm signal 120 outputted by the alarm processor 12, the automatic program processor 14 further automatically checks a task list in the task sending processor 13, and analyzes the alarm signal 120 to adjust a plurality of execution tasks in the task list and automatically trigger the execution of tasks such as issuing an alarm signal, blocking source IPs, conducting compliance rule reviews, backing up network settings, and performing other network management operations. In this embodiment, the alarm processor 12 includes an intelligent learning model 121 that continuously uses historical data and trends for automatic calculation and learning to adjust the alarm value, so as to achieve the effect of intelligently enhancing the accuracy of the alarm signal 120.

The processors of the present disclosure are realized by means of hardware or software supplemented by hardware, for example, the data monitoring processor 10, the data analysis processor 11, the alarm processor 12, the task sending processor 13, the automatic program processor 14, the flow plotting processor 15 and the display processor 16 are defined essentially in the nature of an integration of various hardware devices such as CPUs, microprocessors, memories, circuitry, or signal transmitters, etc. and supplemented with software programs to achieve their technical characteristics.

What is claimed is:

1. A visual monitoring system for balancing server loads and virtual resources, comprising a data monitoring processor, a data analysis processor, an alarm processor, and a display processor, the data monitoring processor being connected to at least one server load balancer and at least one virtual machine, the data analysis processor being connected to the data monitoring processor and the alarm processor, the alarm processor being connected to the display processor, wherein:
the visual monitoring system further comprises a flow plotting processor, connected between the alarm processor and the display processor, and the data analysis processor comprises a load balancing weight calculation model,
the data monitoring processor polls the at least one server load balancer to obtain a plurality of load status data through at least one transmission protocol and polls the at least one virtual machine to obtain a plurality of resource pool status data through the at least one transmission protocol, and the data analysis processor uses the load balancing weight calculation model to compute the plurality of load status data and the resource pool status data corresponding to the at least one transmission protocol for a period of time to obtain an average load data and an average resource data,
the alarm processor uses a built-in alarm value to compare each of the average load data and each of the average resource data, and outputs an alarm signal when an error occurs, and
the flow plotting processor compiles each of the average load data and each of the average resource data to generate at least one integrated flow variation diagram of a topology diagram provided for the display processor to display the at least one integrated flow variation diagram and the alarm signal in real time.

2. The visual monitoring system according to claim 1, wherein the data monitoring processor polls the at least one server load balancer through a first transmission protocols, which comprises a Simple Network Management Protocol (SNMP), an Application Programming Interface (API), and Syslog, to obtain the plurality of load status data including performance, flow, and error conditions, at the same time, the data monitoring processor polls the at least one virtual machine through a second transmission protocols, which comprises the SNMP and the API, to obtain the plurality of resource pool status data including resource usage, performance indicators, and error messages, and
the data analysis processor accumulates the plurality of load status data corresponding to each of the first transmission protocols within the period of time and assigns weights to calculate the average load data, and accumulates the plurality of resource pool status data corresponding to each of the second transmission protocols within the period of time and assigns weight to calculate the average resource data.

3. The visual monitoring system according to claim 2, wherein the data monitoring processor polls the at least one server load balancer and the at least one virtual machine through the SNMP and the API to collect data every N seconds, and to poll the at least one server load balancer through the Syslog to collect data every M seconds.

4. The visual monitoring system according to claim 3, wherein, when the data analysis processor checks and learns that the received plurality of load status data corresponds to the SNMP, the API, and the Syslog, respectively, the load balancing weight calculation model uses a weight ratio of A:B:C to perform data fusion and calculate an average of the plurality of load status data to obtain the average load data during the period of time.

5. The visual monitoring system according to claim 4, wherein, when the data analysis processor checks and learns that the received plurality of load status data corresponds to the SNMP and the API, respectively, but does not obtain the plurality of load status data corresponding to the Syslog, the load balancing weight calculation model uses a weight ratio of D:E to perform the data fusion and calculate the average of the plurality of load status data to obtain the average load data during the period of time.

6. The visual monitoring system according to claim 5, wherein, when the data analysis processor checks and learns that the received plurality of resource pool status data corresponds to the SNMP and the API, respectively, the load balancing weight calculation model uses the weight ratio of D:E to perform data fusion and calculate an average of the plurality of resource pool status data to obtain the average resource data during the period of time.

7. The visual monitoring system according to claim 6, wherein the period of time is 1-10 minutes, N and M are 1-10, A:B:C is 2:1:7, and D:E is 6:4.

8. The visual monitoring system according to claim 6, wherein, when the data analysis processor checks the received plurality of load status data and the plurality of resource pool status data, the load balancing weight calculation model evaluates data variability by calculating a standard deviation of each data source through a formula, and combines data from different sources for trend analysis, and
the load balancing weight calculation model is based on the fused data to perform anomaly detection to identify abnormal situations in real time.

9. The visual monitoring system according to claim 8, further comprising a task sending processor, coupled to the alarm processor and the flow plotting processor, and provided for designing system tasks and performing allocation and management, wherein
the alarm processor comprises an intelligent learning model provided for continuously using history data and trend to automatically calculate and adjust the alarm value, so as to achieve an effect of intelligently enhancing an accuracy of the alarm signal.

10. The visual monitoring system according to claim 9, further comprising an automatic program processor, coupled to the task sending processor, such that when the task sending processor receives the alarm signal, the automatic program processor automatically checks a task list in the task sending processor, and adjusts a plurality of execution tasks in the task list according to the alarm signal.
